(19) United States
(12) Patent Application Publication
(10) Pub. No.: US 2006/0239870 A1
(43) Pub. Date: Oct. 26, 2006

(54) Candle warmer

(76) Inventors: R. Rex Schutte, West Chester, PA (US); Chad Kerstetter, Richfield, PA (US); Sherry Royer, Winfield, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/392,117

(22) Filed: Mar. 29, 2006

Related U.S. Application Data
(60) Provisional application No. 60/673,922, filed on Apr. 22, 2005.

(51) Int. Cl. A62B 7/08

(52) U.S. Cl. 422/125

(57) ABSTRACT

Disclosed is an appliance which accommodates scented candles of different sizes within a hollow surround and allows for the heating of said candle without burning the candle, thereby releasing the aromatic fragrance of the candle. An adjustable rack supports candles of different sizes and shapes above the heating element. The rack is adjusted between a plurality of positions, said portion respectively adapted to support candles of different configurations.

### RELATED U.S. APPLICATION DATA

The present application claims the benefit of U.S. Provisional No. 60/673,922 filed Apr. 22, 2005, which is incorporated herein by reference.

### FIELD OF THE INVENTION

The present invention relates to candle warmers and has particular application to components of the candle warmer which enables it to be used with candles of various sizes and shapes.

### BACKGROUND OF THE INVENTION

Candle warmers are used to enable a household to enjoy the fragrance of scented candles without the need for burning the candle, thereby avoiding the risk of fire or other damage which may result from the presence of an open flame. For use with the candle warmers, the scented candles include a shell, which may be a glass container, normally in standard widths of 4″. The shell contains the wax which is melted when the candle burns or is heated. Some suppliers provide decorative candles which have greater diameter or different sizes or shapes such as ovals. Although numerous patents show devices for releasing aromatic fragrance by the use of light bulbs or hot plates, those patents do not show a holder which may accommodate candles of two different sizes to position the candle over a heat source. Also, while some candle holders accommodate candles of different sizes, these patents do not show a warming device for centering different sized candles over a heat source. The instant invention provides a way to heat scented candles of different sizes without burning the candle itself.

### SUMMARY OF THE INVENTION

The present invention enables a single candle warmer appliance to be used for standard diameter candles as well as candle containers having different diameters or different shapes such as ovals. For example, in one embodiment, the present invention provides a rack which may fit within a surround which, in one position will firmly support a 4″ candle centrally within the surround and in a second position will support candle containers having a diameter larger than the standard 4″ diameter. In another embodiment, in one position the rack may hold a pair of round candles and in another position holds a candle of a different shape such as an oval.

### BRIEF DESCRIPTION OF THE DRAWINGS

The invention will be described more fully in connection with the drawings, in which:

FIG. 1 is a perspective view of a candle warmer embodying the present invention;

FIG. 2 is a sectional view to illustrate the interior of the surround including the heating element and the rack made in accordance with the first embodiment of this present invention;

FIG. 3 is a perspective view of the rack of FIG. 2 removed from the surround;

FIG. 4 is a side view of the rack;

FIG. 5 is a perspective view of a rack in accordance with a second embodiment of the invention;

FIG. 6 is a plan view of the rack of FIG. 5 in a position to support two cylindrical candle containers; and

FIG. 7 is a plan view of the rack of FIG. 5 inverted so as to support an oval container.

### DESCRIPTION OF THE PREFERRED EMBODIMENTS

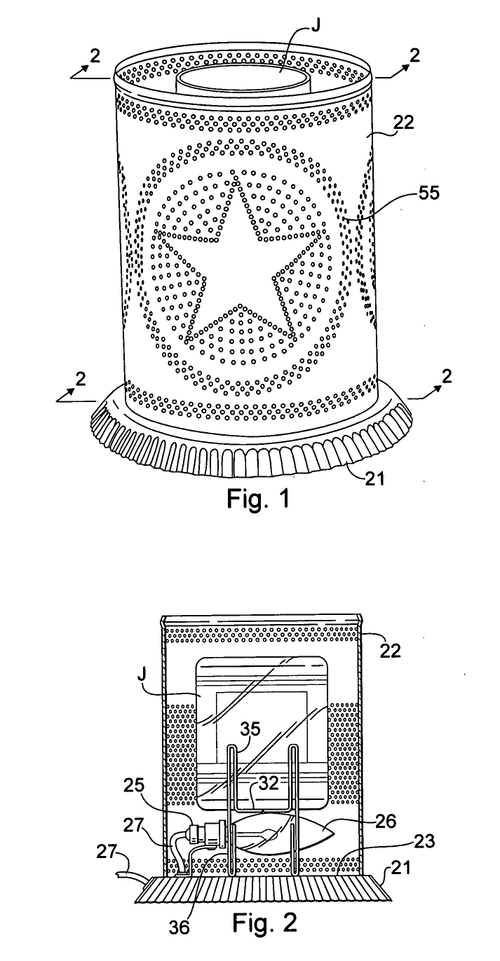

As shown in FIG. 1, the warmer consists of a base 21 on which is mounted an upstanding hollow surround 22. Mounted on the floor 23 of the base 21 within the surround is a lamp socket 25 having a lamp bulb 26. The lamp bulb is energized by electricity supplied by a cord 27. The socket and lamp constitute a heating element which is confined to the lower area of the enclosure within the surround 22. It has been found that a 60-watt bulb provides sufficient heat to melt a candle within the surround. In the illustrated embodiment the surround 22 comprises a cylindrical shell which is perforated to provide a decorative design which renders the shell translucent.

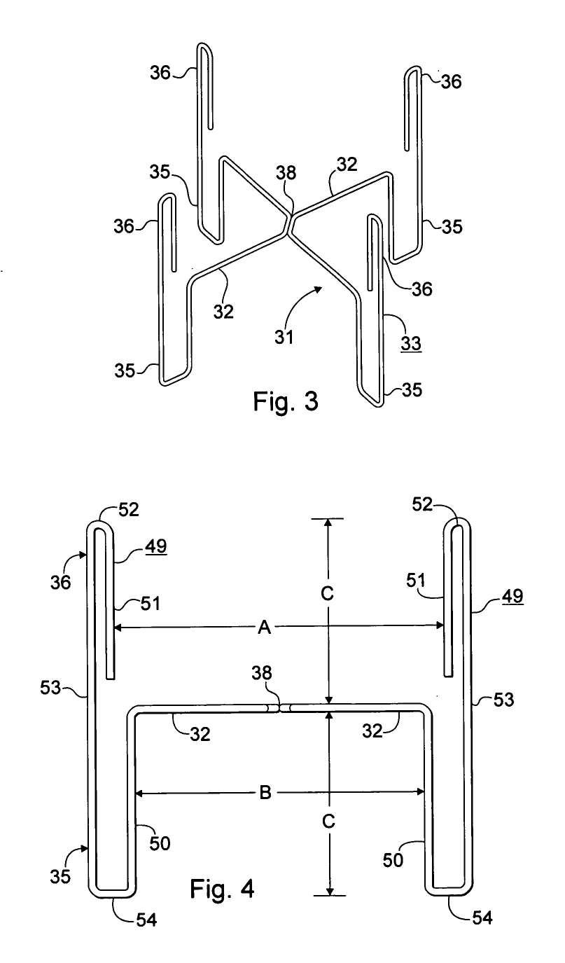

An adjustable support for a candle J is provided on the base to support the candle above the bulb with sufficient clearance to enable the circulation of heat under the candle and along the sides between the outside of the candle J and the inside of the surround 22. The socket 25 supports the bulb 26 above floor 23 of the base 21 within the surround 22. The adjustable candle support comprises a wire rack 31 having horizontal support segments 32 and upstanding spacers 33 positioned around the periphery of the support segments 32. Further, the support is adjustable to provide multiple receivers for different size candles in two positions. Each position accommodates a different candle size or shape. The receiver, while in one position, may be inverted so as to expose the receiver in the other position. Also, by having the support segments elevated from the floor 23, and spaced from the surround 22, the heat from the heat source is able to circulate under the candle and between the candle and the surround. In the present instance, there are four spacers 33 spaced at 90° about the outer periphery of the support segments 32. As shown in FIGS. 3 and 4, each spacer 33 has a wide leg 35 and a narrow leg 36. The distances between the distal ends of the legs 35 and 36 and the support segments 32 are the same and this distance is indicated by the dimension C in FIG. 4. The dimension C is sufficiently large to space the support segments 32 above the heating element when the distal ends of either of the legs 35 and 36 are at rest on the floor 23 of the base 21. The dimension C is sufficient to provide space for venting the heating element.

In the present instance, the rack 31 is formed from two spacers connected at their mid-point at a connection 38, as shown in FIGS. 3 and 4. Each spacer has a narrow leg 36 and a wider leg 35 terminating in a support segment 32. As shown in FIG. 4, the diagonally opposite legs 36 are spaced apart by a dimension indicated at A and the wider legs 35 are spaced apart a smaller distance indicated by the dimension B. In the present instance, the dimension B corresponds to the standard diameter of a jar candle and the dimension A is larger so as to be able to cradle a candle container having a larger diameter but still space the outer wall of the container away from the surround 22. Thus, the legs 36 define a large diameter receptacle for receiving a candle container of with a dimension larger than the standard dimension. A larger than standard candle container may be mounted in the warmer when the support 31 is mounted as shown in FIG. 4. When it is desired to mount a standard candle container in the warmer, the rack is removed and inverted so that the legs 35 are facing upwardly to cradle the standard candle container.

Further, each spacer is made up of a piece of bent wire as described above. Each short length of wire may be referred to as a run. Accordingly, several different runs are present in each spacer in order to support the candle. More specifically, each spacer has a continuous length of wire 49 bent so as to have a terminal 51 portion with a reverse bend 52 bent back to form a vertical run 53 which combines with the portion 49 to provide the narrow leg 36 and at the opposite end of the run 53, the wire is bent back upon itself with a reverse bend 54 to provide an intermediate portion 50 which combines with the vertical run 53 to form the wider leg 35, wherein the terminal run 51 is perpendicular to the base, the reverse bend 52 is parallel with the base, the vertical run 53 is perpendicular with the base, and the reverse bend 54 is parallel with the base. The straight run is the simplest form of wire, however each run does not have to be a straight piece of wire. Rather, the runs could be modified to serve an ornamental purpose.

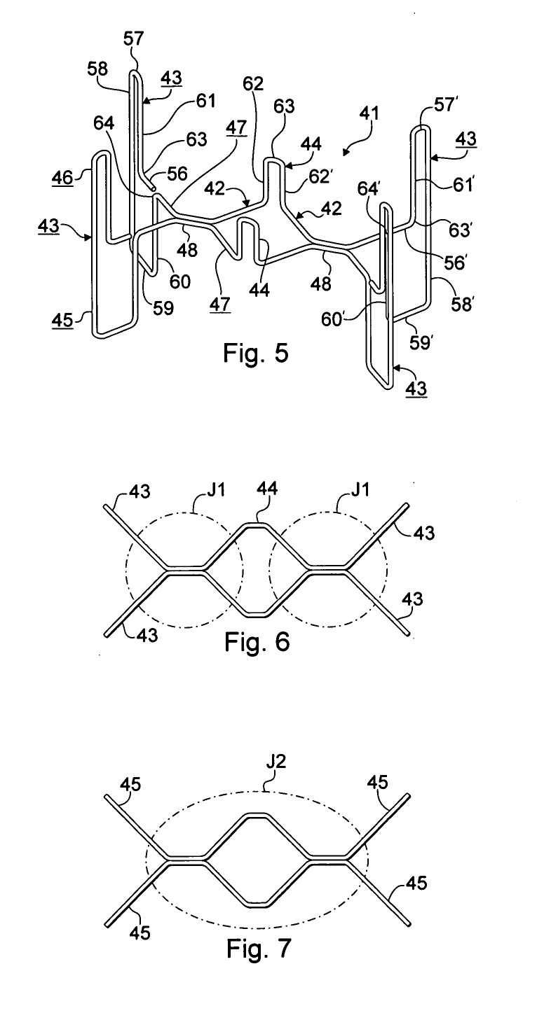

The candle warmer may accommodate other sizes and shapes of candles by simply replacing the rack within the surround. FIG. 5 illustrates a second embodiment of the rack. In this embodiment, the rack 41 has four upstanding outer spacers 43 positioned around the outer periphery of the support segments 42. In addition, there are intermediate spacers 44 projecting from the support segments 42 intermediate the spacers 43. Each outer spacer 43 has a wide leg 45 and a narrow leg 46. The intermediate spacers 44 project in the same direction as one set of legs in the present instance the narrow legs 46 and, as shown in FIG. 6, the intermediate spacers 44 cooperate with the narrow legs 43 to provide support for two cylindrical candle containers of small diameter as indicated at J1. Inverting the rack 41, as shown in FIG. 7, enables an elliptical candle container J2 to be supported on the support segments 42 between the wide legs 45. As in this first embodiment, the vertical extent of the legs 45 and 46 are equal to each other and will position the support segments 42 above the floor of the base by the dimension C in FIG. 4. The rack 41 is made from two spacers 47 of wire connected at two points 48. As in the example described above, several runs are present in each spacer to support the candle. Each spacer is a continuous length of wire bent so as to have a terminal 56 portion with a bend 63 and a run 61 perpendicular with the base, a reverse bend 57 bent back to form a vertical run 58 which combines with the run 61 to provide the narrow leg 46 and at the opposite end of the run 58, the wire is bent back upon itself with a reverse bend 59 to provide an intermediate portion 60 which combines with the vertical run 58 forming the wider leg 45, wherein the terminal run 56 is parallel to the floor, the run 61 is perpendicular with the base, the reverse bend 57 is parallel with the base, the vertical run 58 is perpendicular with the base, the reverse bend 59 is parallel with the base, and the intermediate portion 60 is perpendicular with the base. The run 60 is connected to a run of the support 42 by a bend 64. At the inner end of the support run, the intermediate spacer 44 is provided by vertical runs 62 and 62′ which are connected by a reverse bend 63. Beyond the reverse bend 63, the support 42 has runs which are the mirror image of the runs 56 through 64. These runs are identified with reference numbers 64′-56′.

The surround 22 can be any one of a variety shapes for enclosing the heating apparatus. For instance, the surround may be a circular shape, as shown in FIG. 1 and FIG. 2, for use in conjunction with a rack 31 that accommodates a circular candle. A surround of this shape would also be adapted for use with the rack shown in FIG. 3 and FIG. 4. However, the surround may also be an oval shape, for example, when used with the second embodiment of the rack that accommodates an oval candle or a pair of candles, as shown in FIGS. 5-7. The surround can also be made out of various materials. In the present instance, the surround 22 is formed of sheet metal and is perforated with an ornamental design 55 so that the warmer may serve as a night light while maintaining the candle wax in a melted state within the container or containers. The surround may be made of a translucent material. Further, the surround may be perforated to enable the dissemination of the heat and aroma generated by the heat source. Additionally, the heat source in this instance is a light bulb, but other heat sources may be accommodated below the spacer 32.

While particular embodiments of the invention have been herein illustrated and described changes and modifications may be made without departing from the invention.

What is claimed is:

1. A candle warmer appliance for heating a candle in a shell, comprising a hollow surround mounted on a floor, an adjustable support having horizontal support segments which are mounted for adjustment between at least two positions to receive candles with different size containers, said support segments being spaced above the floor in each position, and a heating element mounted on the floor below said support segments to heat the candle when supported by said support.

2. The appliance of claim 1, including means to mount said heating element on the base below the candle, said adjustable support comprising at least two receivers for different size candles one receiver being exposed in one of said two positions of the support and a second receiver being exposed in a second position of said support and spaced above the floor to enable the circulation of heat under the container and along the sides between the outside of the candle and the inside of the surround.

3. The adjustable support of claim 2, wherein the support comprises a wire rack having legs and a horizontal support segment horizontally positioned above the heating element with sufficient space to receive the heating element and with the distal ends of the legs at rest on the floor, said rack including upstanding spacers, said spacers having at least one pair of wide legs and at least one pair of narrow legs, said narrow legs projecting in one direction perpendicular to the horizontal support segments, the wide legs projecting in a direction opposite to the one direction perpendicular to the horizontal support segments.

4. The wire rack of claim 3, wherein the horizontal support segments comprise two lengths of wire that connect at a midpoint, and each spacer comprises continuous length of wire bent so as to have a terminal portion with a reverse bend bent back to form a vertical run which combines with the portion to provide the narrow leg and at the opposite end of the run, the wire is bent back upon itself with a reverse bend to provide an intermediate portion which combines with the vertical run forming the wider leg, wherein the terminal run is perpendicular to the base, the reverse bend is parallel with the base, the vertical run is perpendicular with the base, the reverse bend is parallel with the base.

5. The appliance of claim 4, wherein the width dimension between the legs is greater than the outside dimension of the candle adapted to be inserted therein.

6. The appliance of claim 4, wherein the appliance accommodates candles of different widths, wherein the length dimension of each leg is sufficient to space the support spacers above the heating element, and wherein the width dimension between the legs corresponds to a standard diameter of a candle.

7. The appliance of claim 6, wherein the appliance accommodates candle containers of different widths, wherein the length dimension is sufficient to space the support spacers above the heating element and wherein the width outside of the legs is less than the width dimension of the surround to provide space for venting the heating element.

8. The appliance of claim 6, wherein the adjustable support has upper and lower legs extending above and below said horizontal support said support having a given width dimension between said upper legs, said lower legs having a length dimension sufficient to space the support spacers above the heating element.

9. The appliance of claim 7, including upstanding outer spacers positioned around the periphery of support segments and intermediate spacers projecting from the support segments intermediate the spacers, allowing support of two cylindrical candles of small diameter between said outside and intermediate spacers.

11. The appliance of claim 9, including an oval candle supported by the support segments between the wide legs.

12. The appliance of claim 1, wherein the hollow surround is translucent and is illuminated by light from the heat source so that the appliance acts as a nightlight.

13. The appliance of claim 12, wherein the translucent surround comprises a shell perforated with an ornamental design which may be illuminated by light from the heat source so that the appliance acts as a nightlight.
